(19) United States
(12) Patent Application Publication
(10) Pub. No.: US 2021/0319173 A1
(43) Pub. Date: Oct. 14, 2021

(54) DETERMINING SYNTAX PARSE TREES FOR EXTRACTING NESTED HIERARCHICAL STRUCTURES FROM TEXT DATA

(71) Applicant: RSA Security LLC, Bedford, MA (US)

(72) Inventors: Gregory A. Gerber, JR., Colorado Springs, CO (US); Sashka T. Davis, Vienna, VA (US)

(21) Appl. No.: 16/844,046

(22) Filed: Apr. 9, 2020

(51) Int. Cl. G06F 40/211; G06F 16/31; G06F 16/93

(52) U.S. Cl. CPC G06F 40/211; G06F 16/93; G06F 16/31

(57) ABSTRACT

An apparatus comprises a processing device configured to obtain an unstructured version of a document comprising text data having a nested hierarchical structure comprising two or more levels, and to determine a syntax parse tree for the nested hierarchical structure specifying one or more list types associated with items in at least a given one of the levels in the nested hierarchical structure. The processing device is also configured to identify, in the document, a plurality of items each having one of the specified one or more list types in the syntax parse tree, to extract, from the document, portions of the text data corresponding to respective ones of the plurality of items, and to generate a structured version of the document that associates the extracted portions of the text data with the corresponding ones of the plurality of items.

### FIELD

The field relates generally to information processing, and more particularly to techniques for managing unstructured data.

### BACKGROUND

In many information processing systems, data stored electronically is in an unstructured format, with documents comprising a large portion of unstructured data. Collection and analysis, however, may be limited to highly structured data, as unstructured text data requires special treatment. For example, unstructured text data may require manual screening in which a corpus of unstructured text data is reviewed and sampled by service personnel. Alternatively, the unstructured text data may require manual customization and maintenance of a large set of rules that can be used to determine correspondence with predefined themes of interest. Such processing is unduly tedious and time-consuming, particularly for large volumes of unstructured text data.

### SUMMARY

Illustrative embodiments of the present invention provide techniques for determining syntax parse trees for extracting nested hierarchical structures from text data, such as text data in unstructured versions of documents.

In one embodiment, an apparatus comprises at least one processing device comprising a processor coupled to a memory. The at least one processing device is configured to perform the steps of obtaining an unstructured version of a document comprising text data, the text data having a nested hierarchical structure comprising two or more levels, and determining a syntax parse tree for the nested hierarchical structure, the syntax parse tree specifying one or more list types associated with items in at least a given one of the two or more levels in the nested hierarchical structure. The at least one processing device is also configured to perform the steps of identifying, in the document, a plurality of items each having one of the specified one or more list types in the syntax parse tree, extracting, from the document, portions of the text data corresponding to respective ones of the plurality of items, and generating a structured version of the document that associates the extracted portions of the text data with the corresponding ones of the plurality of items.

These and other illustrative embodiments include, without limitation, methods, apparatus, networks, systems and processor-readable storage media.

### BRIEF DESCRIPTION OF THE DRAWINGS

FIG. 1 is a block diagram of an information processing system for determining syntax parse trees for extracting nested hierarchical structures from text data in an illustrative embodiment of the invention.

FIG. 2 is a flow diagram of an exemplary process for determining syntax parse trees for extracting nested hierarchical structures from text data in an illustrative embodiment.

FIG. 3 shows an example of a regulatory document in an illustrative embodiment.

FIG. 4 shows another example of a regulatory document in an illustrative embodiment.

FIG. 5 shows pseudocode for implementing a document content extraction process in an illustrative embodiment.

FIGS. 6A-6C shows portions of another example of a regulatory document in an illustrative embodiment.

FIGS. 7 and 8 show examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources.

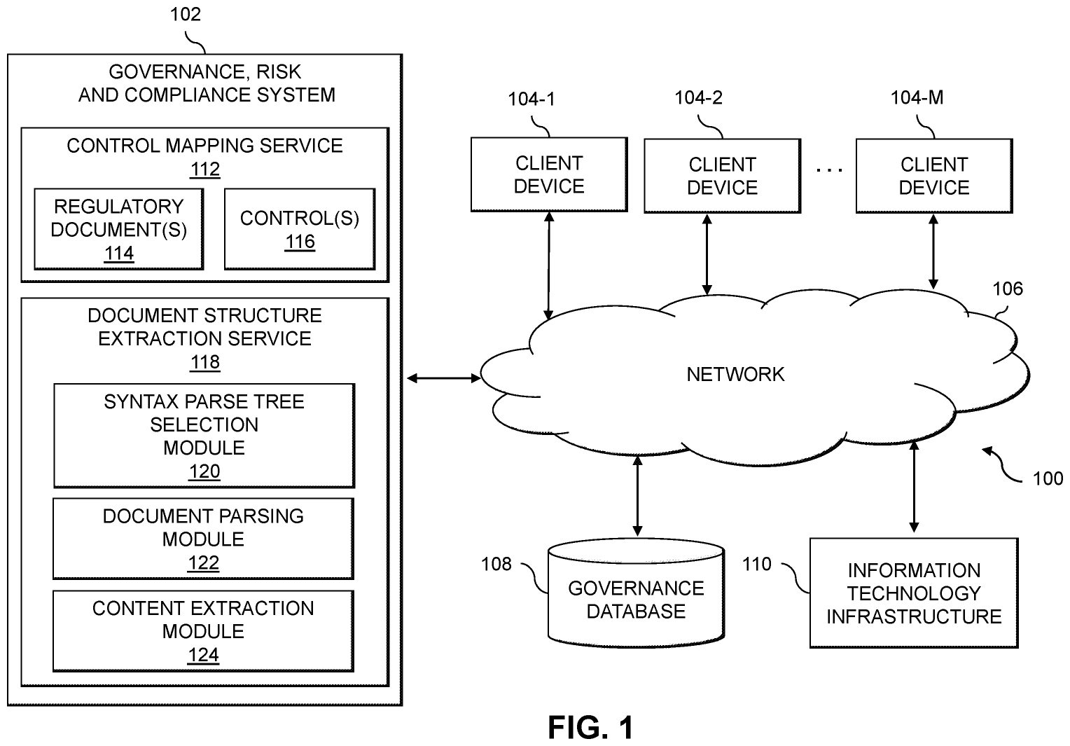

FIG. 1 shows an information processing system 100 configured in accordance with an illustrative embodiment. The information processing system 100 is assumed to be built on at least one processing platform and provides functionality for determining syntax parse trees for extracting nested hierarchical structures from text data. The information processing system 100 includes a governance, risk and compliance (GRC) system 102 and a plurality of client devices 104-1, 104-2, . . . 104-M (collectively client devices 104). The GRC system 102 and client devices 104 are coupled to a network. Also coupled to the network 106 is a governance database 108, which may store various information relating to governance of a plurality of assets of information technology (IT) infrastructure 110 also coupled to the network 106. The assets may include, by way of example, physical and virtual computing resources in the IT infrastructure 110. Physical computing resources may include physical hardware such as servers, storage systems, networking equipment, Internet of Things (IoT) devices, other types of processing and computing devices, etc. Virtual computing resources may include virtual machines (VMs), containers, etc.

The client devices 104 may comprise, for example, physical computing devices such as IoT devices, mobile telephones, laptop computers, tablet computers, desktop computers or other types of devices utilized by members of an enterprise, in any combination. Such devices are examples of what are more generally referred to herein as “processing devices.” Some of these processing devices are also generally referred to herein as “computers.” The client devices 104 may also or alternately comprise virtualized computing resources, such as VMs, containers, etc.

The client devices 104 in some embodiments comprise respective computers associated with a particular company, organization or other enterprise. In addition, at least portions of the system 100 may also be referred to herein as collectively comprising an “enterprise.” Numerous other operating scenarios involving a wide variety of different types and arrangements of processing nodes are possible, as will be appreciated by those skilled in the art.

The network 106 is assumed to comprise a global computer network such as the Internet, although other types of networks can be part of the network 106, including a wide area network (WAN), a local area network (LAN), a satellite network, a telephone or cable network, a cellular network, a wireless network such as a WiFi or WiMAX network, or various portions or combinations of these and other types of networks.

The governance database 108, as discussed above, is configured to store and record information relating to governance of the IT infrastructure 110. Such information may include information describing a set of laws, regulations, policies, contracts, obligations or other rules that one or more enterprises operating the IT infrastructure 110 are subject to, as well as controls of the IT infrastructure 110 used to demonstrate compliance with the set of laws, regulations, policies, contracts, obligations or other rules. The set of laws, regulations, policies, contracts, obligations or other rules that a particular entity is subject to may be collectively referred to herein as “regulations.”

The governance database 108 in some embodiments is implemented using one or more storage systems or devices associated with the GRC system 102. In some embodiments, one or more of the storage systems utilized to implement the governance database 108 comprises a scale-out all-flash content addressable storage array or other type of storage array.

The term “storage system” as used herein is therefore intended to be broadly construed, and should not be viewed as being limited to content addressable storage systems or flash-based storage systems. A given storage system as the term is broadly used herein can comprise, for example, network-attached storage (NAS), storage area networks (SANs), direct-attached storage (DAS) and distributed DAS, as well as combinations of these and other storage types, including software-defined storage.

Other particular types of storage products that can be used in implementing storage systems in illustrative embodiments include all-flash and hybrid flash storage arrays, software-defined storage products, cloud storage products, object-based storage products, and scale-out NAS clusters. Combinations of multiple ones of these and other storage products can also be used in implementing a given storage system in an illustrative embodiment.

Although not explicitly shown in FIG. 1, one or more input-output devices such as keyboards, displays or other types of input-output devices may be used to support one or more user interfaces to the GRC system 102, as well as to support communication between the GRC system 102 and other related systems and devices not explicitly shown.

The client devices 104 are configured to access or otherwise utilize assets of the IT infrastructure 110. In some embodiments, the assets (e.g., physical and virtual computing resources) of the IT infrastructure 110 are operated by or otherwise associated with one or more companies, businesses, organizations, enterprises, or other entities. For example, in some embodiments the assets of the IT infrastructure 110 may be operated by a single entity, such as in the case of a private data center of a particular company. In other embodiments, the assets of the IT infrastructure 110 may be associated with multiple different entities, such as in the case where the assets of the IT infrastructure 110 provide a cloud computing platform or other data center where resources are shared amongst multiple different entities. As noted above, the IT infrastructure 110 is assumed to be subject to a set of regulations. The IT infrastructure 110, or an enterprise or other entity operating at least a portion of the assets thereof, may be required to demonstrate compliance with the set of regulations to users of one or more of the client devices 102. The GRC system 102 facilitates the IT infrastructure 110's compliance with the set of regulations, as well as with demonstrating such compliance.

The term “user” herein is intended to be broadly construed so as to encompass numerous arrangements of human, hardware, software or firmware entities, as well as combinations of such entities.

In the present embodiment, alerts or notifications generated by the GRC system 102 (e.g., a control mapping service 112 thereof, a document structure extraction service 118 thereof, etc.) are provided over network 106 to client devices 104, or to a system administrator, IT manager, or other authorized personnel via one or more host agents. Such host agents may be implemented via the client devices 104 or by other computing or processing devices associated with a system administrator, IT manager or other authorized personnel. Such devices can illustratively comprise mobile telephones, laptop computers, tablet computers, desktop computers, or other types of computers or processing devices configured for communication over network 106 with the GRC system 102, the control mapping service 112, and the document structure extraction service 118. For example, a given host agent may comprise a mobile telephone equipped with a mobile application configured to receive alerts or notifications from the GRC system 102 (e.g., when new regulations are detected, when compliance with one or more existing regulations has failed, etc.), from the control mapping service 112 (e.g., prompts to confirm the mapping of portions of one or more regulatory documents 114 to one or more controls 116), from the document structure extraction service 118 (e.g., prompts for examples of items in different levels of an internal hierarchical structure of the one or more regulatory documents 114, prompts for confirming the accuracy of content extracted from the one or more regulatory documents 114, etc.). The given host agent provides an interface for responding to such various alerts or notifications as described elsewhere herein.

It should be noted that a “host agent” as this term is generally used herein may comprise an automated entity, such as a software entity running on a processing device. Accordingly, a host agent need not be a human entity.

As shown in FIG. 1, the GRC system 102 comprises the control mapping service 112 and the document structure extraction service 118.

The control mapping service 112 is configured to identify regulations that apply to the IT infrastructure 110 from one or more regulatory documents 114, and to map regulations in the one or more regulatory documents 114 to a set of one or more controls 116. To do so, requirements are identified and extracted from the regulatory documents 114 and mapped to the internal controls 116 applied to assets of the IT infrastructure 110, such that an operator of the IT infrastructure 110 can easily demonstrate (e.g., to users of the client devices 104) that it complies with those requirements. The GRC system 102 may provide solutions for Regulatory & Corporate Compliance Management (RCCM) for managing the ever-changing laws and regulations that an entity which operates at least a subset of the assets of the IT infrastructure 110 must comply with. The entity must also document the controls 116 put into place, where the controls 116 may be implemented as documents that describe how the entity meets the requirements set forth by the regulatory documents 114. The regulatory documents 114, also referred to herein as “authoritative sources.” To maintain compliance, the controls 116 may need to be continually updated to adapt to changing and new regulations in the regulatory documents 114.

A given authoritative source (e.g., a given one of the regulatory documents 114) may comprise a document with an internal hierarchical structure (e.g., with several levels, each having a unique identifier (ID) and title). Though the given authoritative source has the internal hierarchical structure contained therein, the given authoritative source may be stored in electronic form as an unstructured document. The unstructured document is assumed to comprise text data that has some internal hierarchical structure that is not defined in the electronic form of the document, and thus the text data appears, from a computing perspective, to be unstructured text data. The document structure extraction service 118, as will be described in further detail below, enables efficient extraction of the internal hierarchical structure from authoritative sources such as the regulatory documents 114 to create or output structured data that is utilized by the control mapping service 112 to map to the controls 116 (e.g., documents that contain statements with instructions for complying with regulations) utilized by one or more entities operating assets of the IT infrastructure 110. The regulatory documents 114 and controls 116 may both include or otherwise utilize tags (e.g., terms that are used to generally describe subjects).

The control mapping service 112, in some embodiments, implements a recommender system for mapping between the regulatory documents 114 and the controls 116. The control mapping service 112 is configured to obtain a current set of authoritative sources providing the regulatory documents 114, a current set of controls 116, and the current mappings between them from the governance database 108. The control mapping service 112 is configured to receive one or more new regulatory documents 114 (e.g., from one or more of the client devices 104) and generates recommendations for how to map such new regulatory documents 114 to existing or new ones of the controls 116.

In some embodiments, one or more of the client devices 104 upload new regulatory documents 114 to the control mapping service 112 (or to the governance database 108, where the control mapping service 112 periodically checks the governance database 108 for new regulatory documents 114 to be mapped), performs analytics to calculate the probability that respective ones of the new regulatory documents 114 should be mapped into each of the controls 116, and then generates a set of mapping recommendations. In some embodiments, the mapping recommendations may be provided to one or more of the client devices 104, to allow one or more users thereof to approve, reject or edit the mapping recommendations before they are implemented. In other embodiments, however, the mapping recommendations may be implemented automatically (e.g., without first providing the recommendations to one or more of the client devices 104).

The control mapping service 112 may be trained based on the existing set of regulatory documents 114, controls 116 and mappings before generating the recommendations for new mappings for one or more new regulatory documents 114. For example, each document level in the internal hierarchical structure in the existing set of regulatory documents 114 may be transformed into a vector that best represents its content. To do so, term frequency-inverse document frequency (TF-IDF) techniques may be utilized, which create a vector where each element in the vector represents a word and the value of each element is the TF-IDF value calculated based on the corpus of existing regulatory documents 114. Various other techniques may be used for creating the vector, such as text vectorization using neural network auto-encoders, word embedding, etc. Similar vectorization methods are performed for the text of the existing set of controls 116.

The vector representations of the existing regulatory documents 114 and controls 116 are used to train a multi-label classifier. The multi-label classifier is used to enable prediction of tags for new regulatory documents 114. The multi-label classifier uses the existing tags that the current or existing set of regulatory documents 114 and controls 116 have as a target variable. The multi-label classifier may utilize various algorithms, such as a binary relevance algorithm with random forest as the base classifier, or any other available multi-label classifier. Using the existing mappings between the regulatory documents 114 and the controls 116, a training set and a validation set of mappings are constructed, where the validation set is being considered as new regulatory documents 114. With this, the processing described in the following paragraphs may be performed to extract features for each of the controls 116 in the training set that are considered to be mapped to the regulatory documents 114 that are in the validation set. Because the fact that whether a mapping exists or not in the validation set is known, the multi-label classifier may be trained to predict the probability of whether a mapping exists based on the provided features.

Given a new regulatory document 114 to be mapped to controls 116, the control mappings service 112 may perform the following processing. First the internal hierarchical structure of the new regulatory document 114 is extracted utilizing the document structure extraction service 118. Each level in the internal hierarchical structure of the new regulatory document 114 is converted into its vector representation based on the different level vectorizers constructed during training.

A similarity score between each level in the internal hierarchical structure of the new regulatory documents 114 and each of the existing regulatory documents 114 is then calculated. In some embodiments, the similarity score may be calculated using a cosine similarity between the vector representation of the new regulatory document 114 and respective ones of the existing regulatory documents 114. The final similarity score may be derived from the different similarity scores for each level in the internal hierarchical structure of the new regulatory document 114. In some embodiments, this includes taking the similarity between the lowest levels available in the regulatory documents 114, averaging the similarities, taking the maximum, etc.

For all existing regulatory documents 114 whose similarity to the new regulatory document 114 is above a certain threshold, the existing controls 116 that were mapped to such existing regulatory documents 114 are selected as candidates for being recommended for mapping to the new regulatory document 114. In some embodiments, the lowest level of the new regulatory document 114 is vectorized using the controls 116 vector constructed during training. A similarity score between this lowest level and the existing controls 116 representation is calculated as described above. All controls 116 whose similarity is above a certain threshold are also taken as candidates to be recommended for mapping to the new regulatory document 114. Tag probabilities for the new regulatory document 114 are predicted using the multi-label classifier trained as described above. A similarity between the predicted tags and the existing tags assigned to each control 116 is then calculated, such as using cosine similarity as described above. For each of the control 116 candidates, a set of features is extracted. The features may include, but are not limited to: the various similarities of the regulatory documents 114 from which it was derived; the final similarity of the regulatory documents 114 from which it was derived; the rank (e.g., based on similarity) of the regulatory document 114 from which it was derived compared to other similar ones of the regulatory documents 114; the similarity to the new regulatory document 114; the rank (e.g., based on similarity) compared to other controls 116; the number of regulatory documents 114 it was derived from; the similarity between the tags; the total number of regulatory documents 114 that the control 116 has been mapped to; the total length (e.g., in words) of the control 116; etc. The extracted features for each control 116 are fed into the trained multi-label classifier, where the trained multi-label classifier predicts how likely each candidate control 116 is to be mapped to the new regulatory document 114 (e.g., a score between 0 and 1). If this score is above a specific threshold, the mapping is recommended.

The recommendations for mapping the new regulatory document 114 to one or more controls 116 may be provided to a user (e.g., of one or more of the client devices 104), where the user may accept, reject, or edit and then accept the recommendations. The user selections (e.g., accepting, rejecting, or editing) may be used for further training and adjustment of the multi-label classifier for providing even more accurate recommendations. In addition, new regulatory documents 114 for which no mapping was found may be grouped together and delivered to the user as a set of regulatory documents that should be mapped to one or more new controls that do not exist in the current set of controls 116.

The control mapping service 112, as described above, may rely on knowing the internal hierarchical structure of the regulatory documents 114. The document structure extraction service 118 is configured to extract the internal hierarchical structure from regulatory documents 114 that are in an unstructured format (e.g., which contain unstructured or loosely-structured text data). A human may be able to identify the structure of a regulatory document and recognize where requirements exist therein. The process of manually reviewing regulatory documents, however, is tedious, time-consuming, and can be error prone (e.g., particularly with lengthy regulatory documents containing large amounts of unstructured text data). The document structure extraction service 118 advantageously automates the extraction of internal hierarchical structure from documents stored in unstructured formats (e.g., new regulatory documents 114 that are to be mapped to the controls 116 by control mapping service 112). To do so, the document structure extraction service 118 utilizes a syntax parse tree selection module 120, a document parsing module 122, and a content extraction module 124.

The document structure extraction service 118 is configured to obtain an unstructured version of a document (e.g., from one or more of the client devices 104, from the governance database 108, etc.). The document comprises text data having a nested hierarchical structure comprising two or more levels. The syntax parse tree selection module 120 is configured to determine a syntax parse tree for the nested hierarchical structure. The syntax parse tree specifies one or more list types associated with items in at least a given one of the two or more levels in the nested hierarchical structure. In some embodiments, the syntax parse tree comprises a context free grammar (CFG) having a depth corresponding to a number of the two or more levels in the nested hierarchical structure, and an ordering of a set of terminal symbols corresponding to an ordering of identifiers for list types of the two or more levels in the nested hierarchical structure. In other embodiments, syntax parse tree comprises a CFG with an arbitrary depth, where a common list type is used for items in each of the two or more levels in the nested hierarchical structure.

The document parsing module 122 is configured to identify, in the document, a plurality of items each having one of the specified one or more list types in the syntax parse tree. The content extraction module 124 is configured to extract, from the document, portions of the text data corresponding to respective ones of the plurality of items, and to generate a structured version of the document that associates the extracted portions of the text data with the corresponding ones of the plurality of items.

The structured version of the document may be provided as one of the document 114 that is mapped to controls 116 by the control mapping service 112. In some embodiments, the control mapping service 112 takes as input one or more designated structured file formats, such as an Extensible Markup Language (XML) format, a JavaScript Object Notation (JSON) format, a Comma Separated Value (CSV) format, etc. For formats such as XML and JSON, the structured version of the document may comprise a list of the identified items each comprising at least one key specifying a unique identifier for a given one of the identified items and parent-child relationships of the given identified item with one or more other items in one or more other ones of the two or more levels in the nested hierarchical structure. For formats such as CSV, the structured version of the document may comprise a CSV file for each of the two or more levels in the nested hierarchical structure, a given one of the CSV files for the given level of the nested hierarchical structure comprising at least one column specifying parent-child relationships of a given one of the identified items with one or more other items in one or more other ones of the two or more levels in the nested hierarchical structure.

Although shown as elements of the GRC system 102 in the FIG. 1 embodiment, one or both of the control mapping service 112 and the document structure extraction service 118 in other embodiments can be implemented at least in part externally to the GRC system 102, for example, as a stand-alone server, set of servers or other type of system coupled to the network 106. In some embodiments, one or both of the control mapping service 112 and the document structure extraction service 118 may be implemented at least in part within one or more of the client devices 104.

The control mapping service 112 and the document structure extraction service 118 in the FIG. 1 embodiment are assumed to be implemented using at least one processing device. Each such processing device generally comprises at least one processor and an associated memory, and implements one or more functional modules for controlling certain features of the control mapping service 112 and the document structure extraction service 118 (e.g., the syntax parse tree selection module 120, the document parsing module 122, and the content extraction module 124).

It is to be appreciated that the particular arrangement of the GRC system 102, the control mapping service 112, and the document structure extraction service 118 illustrated in the FIG. 1 embodiment is presented by way of example only, and alternative arrangements can be used in other embodiments. As discussed above, for example, the GRC system 102, or one or more portions thereof such as the control mapping service 112 or document structure extraction service 118, may in some embodiments be implemented internal to one or more of the client devices 104. As another example, the functionality associated with the syntax parse tree selection module 120, the document parsing module 122, and the content extraction module 124 may be combined into one module, or separated across more than three modules with the multiple modules possibly being implemented with multiple distinct processors or processing devices.

At least portions of the control mapping service 112 and document structure extraction service 118 (e.g., the syntax parse tree selection module 120, the document parsing module 122, and the content extraction module 124) may be implemented at least in part in the form of software that is stored in memory and executed by a processor.

It is to be understood that the particular set of elements shown in FIG. 1 for determining syntax parse trees for extracting nested hierarchical structures from text data is presented by way of illustrative example only, and in other embodiments additional or alternative elements may be used. Thus, another embodiment may include additional or alternative systems, devices and other network entities, as well as different arrangements of modules and other components.

By way of example, in other embodiments, the control mapping service 112 and the document structure extraction service 118 may be implemented external to the GRC system 102, such that the GRC system 102 can be eliminated.

It should also be appreciated that the functionality of the document structure extraction service 118 is not limited solely for use in extracting the structure of regulatory documents 114 to facilitate mapping to controls 116. The functionality of the document structure extraction service 118 may be utilized in various other contexts, such as in the transformation or conversion of unstructured version of a document to a structured version of the document (e.g., by extracting the internal hierarchical structure from unstructured text data therein). This may be useful in various applications, such as analyzing log or event data. Thus, in some embodiments, the document structure extraction service 118 may be part of or otherwise associated with a system other than the GRC system 102, such as, for example, a security operations center (SOC), a critical incident response center (CIRC), a security analytics system, a security information and event management (SIEM) system, etc.

The control mapping service 114 and the document structure extraction service 118, and other portions of the system 100, in some embodiments, may be part of cloud infrastructure as will be described in further detail below. The cloud infrastructure hosting one or both of the control mapping service 112 and the document structure extraction service 118 may also host any combination of the GRC system 102, one or more of the client devices 104, the governance database 108 and the IT infrastructure 110.

The control mapping service 112 and the document structure extraction service 118, and other components of the information processing system 100 in the FIG. 1 embodiment, are assumed to be implemented using at least one processing platform comprising one or more processing devices each having a processor coupled to a memory. Such processing devices can illustratively include particular arrangements of compute, storage and network resources.

The client devices 104 and GRC system 102 or components thereof (e.g., the control mapping service 112 and the document structure extraction service 118) may be implemented on respective distinct processing platforms, although numerous other arrangements are possible. For example, in some embodiments at least portions of one or both of the control mapping service 114 and the document structure extraction service 118 and one or more of the client devices 104 are implemented on the same processing platform. A given client device (e.g., 104-1) can therefore be implemented at least in part within at least one processing platform that implements at least a portion of one or both of the control mapping service 114 and the document structure extraction service 118.

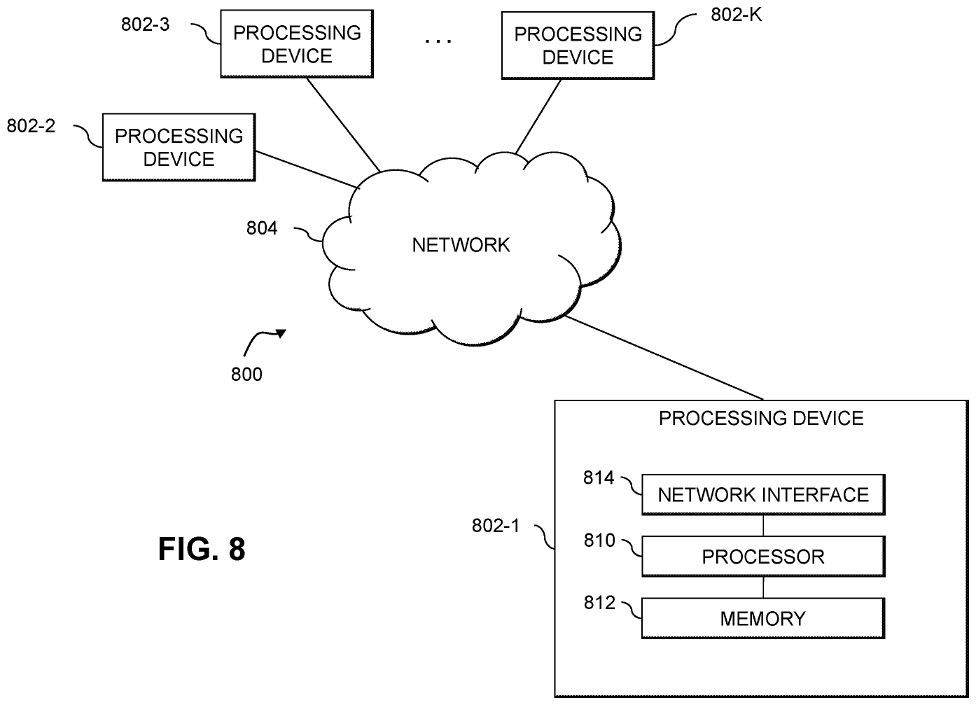

The term “processing platform” as used herein is intended to be broadly construed so as to encompass, by way of illustration and without limitation, multiple sets of processing devices and associated storage systems that are configured to communicate over one or more networks. For example, distributed implementations of the system 100 are possible, in which certain components of the system reside in one data center in a first geographic location while other components of the system reside in one or more other data centers in one or more other geographic locations that are potentially remote from the first geographic location. Thus, it is possible in some implementations of the system 100 for the client devices 104, the GRC system 102 or portions or components thereof (e.g., the control mapping service 112 and the document structure extraction service 118), to reside in different data centers. Numerous other distributed implementations are possible. One or both of the control mapping service 112 and the document structure extraction service 118 can also be implemented in a distributed manner across multiple data centers. Additional examples of processing platforms utilized to implement one or both of the control mapping service 112 and the document structure extraction service 118 in illustrative embodiments will be described in more detail below in conjunction with FIGS. 8 and 9.

It is to be appreciated that these and other features of illustrative embodiments are presented by way of example only, and should not be construed as limiting in any way.

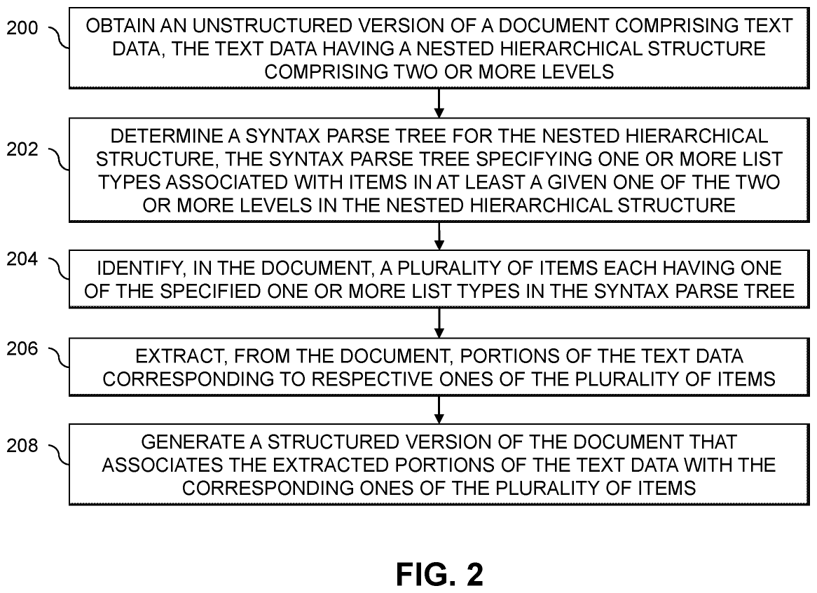

An exemplary process for determining syntax parse trees for extracting nested hierarchical structures from text data will now be described in more detail with reference to the flow diagram of FIG. 2. It is to be understood that this particular process is only an example, and that additional or alternative processes for determining syntax parse trees for extracting nested hierarchical structures from text data can be carried out in other embodiments.

In this embodiment, the process includes steps 200 through 208. These steps are assumed to be performed by the document structure extraction service 118 utilizing the syntax parse tree selection module 120, the document parsing module 122, and the content extraction module 124. The process begins with step 200, obtaining an unstructured version of a document comprising text data. The text data has a nested hierarchical structure comprising two or more levels. In step 202, a syntax parse tree for the nested hierarchical structure is determined. The syntax parse tree specifies one or more list types associated with items in at least a given one of the two or more levels in the nested hierarchical structure.

In step 204, a plurality of items each having one of the specified one or more list types in the syntax parse tree are identified in the document. Portions of the text data corresponding to respective ones of the plurality of items are extracted from the document in step 206. A structured version of the document is generated in step 208 that associates the extracted portions of the text data with the corresponding ones of the plurality of items. In some embodiments, the document comprises a regulatory document specifying one or more requirements for operation of assets in an IT infrastructure, and the FIG. 2 process further includes utilizing the structured version of the document to map the specified one or more requirements to controls for operating the assets in the IT infrastructure.

In some embodiments, the syntax parse tree comprises a CFG having a depth corresponding to a number of the two or more levels in the nested hierarchical structure and an ordering of a set of terminal symbols corresponding to an ordering of identifiers for list types of the two or more levels in the nested hierarchical structure. Determining the syntax parse tree in step 202 may comprise identifying whether respective ones of a set of known list types are present in the document, determining a number of the two or more levels in the nested hierarchical structure, and selecting a CFG with the identified ones of the known list types present in the document and having a depth corresponding to the determined number of the two or more levels in the nested hierarchical structure.

Identifying whether respective ones of the set of known list types are present in the document may comprise, for a given one of the set of known list types, generating a given parser for a CFG of depth one for the given known list type and analyzing the document with the given parser to determine whether any items with the given known list type are found in the document.

Determining the number of the two or more levels in the nested hierarchical structure may comprise generating a plurality of parsers each comprising a combination of two or more identified ones of the known list types at two or more different depths corresponding to different ones of the two or more levels in the nested hierarchical structure, and analyzing the document with respective ones of the plurality of parsers to determine a subset of the plurality of parsers able to successfully parse the document. A given one of the plurality of parsers having a given depth is able to successfully parse the document when the given parser finds at least one item at each level in the given depth. The number of the two or more levels in the nested hierarchical structure is determined as a longest depth among the subset of the plurality of parsers able to successfully parse the document. One of the subset of the plurality of parsers having the longest depth may be selected as the syntax parse tree. When there are two or more parsers in the subset of the plurality of parsers having the longest depth, the two or more parsers having the longest depth may be provided to a client device for selection of one of the two or more parsers having the longest depth as the syntax parse tree.

In other embodiments, the syntax parse tree comprises a CFG with an arbitrary depth where a common list type is used for items in each of the two or more levels in the nested hierarchical structure. Step 204 may include generating a recursive descent parser based at least in part on the CFG, and utilizing the recursive descent parser to identify subsets of the plurality of items at each of the two or more levels in the nested hierarchical structure. The recursive descent parser may comprise a parser function that takes as input an identifier of a given one of the two or more levels in the nested hierarchical structure and a given portion of the text data of the document. When the given level in the nested hierarchical structure comprises a topmost one of the two or more levels in the nested hierarchical structure, the given portion of the text data comprises all of the text data of the document. When the given level in the nested hierarchical structure comprises a first one of the two or more levels in the nested hierarchical structure, the given portion of the text data comprises all text data for a given component in a second one of the two or more levels in the nested hierarchical structure, the second level being higher than the first level. The identifier of the given level in the nested hierarchical structure may indicate a leading portion of enumerations of the common list type to be removed prior to parsing the given portion of the text data of the document.

Many modern companies, organizations, enterprises and other entities exist in a highly regulated environment. An entity, for example, may be required to demonstrate compliance with all applicable regulatory requirements. Regulations are necessary to protect consumers, the environment, and society, but these regulations impose significant costs on entities. To satisfy regulators, entities must identify and understand all requirements. They must demonstrate they maintain an internal control related to each requirement and that their actions (or inactions) meet all requirements. Many of the tasks involved require significant user intervention. Illustrative embodiments reduce the time and effort required to identify and understand requirements. Some embodiments take a legal or other regulatory document and extract its structure, referred to herein as a syntax parse tree. The syntax parse tree enables an entity to quickly and easily map regulatory requirements to internal controls. In some embodiments, techniques are provided for automatically extracting the hierarchical structure of a regulatory document in the form of a regulation's syntax parse tree. The syntax parse tree may be visualized as an augmented outline or augmented table of contents that identifies: (1) all components of a regulation and, when a component has a nested or recursive structure, the syntax parse tree also identifies the lexical structure of each subcomponent at arbitrary depth; and (2) the regulatory text associated with each component and subcomponent.

Techniques described herein enable an automatic approach for deriving a syntax parse tree for a document to identify its hierarchical structure, all components and subcomponents, and their associated text. In some embodiments, a solution combines Natural Language Processing (NLP) and tools from Compiler Theory. Advantageously, the techniques described herein have the added benefit of easy and rapid functional extension. The regulation parser solutions described herein can easily be adapted to recognize evolving and changing regulation styles at a low engineering cost. Further, the regulation parser solutions described herein advantageously do not depend on font styles, text indentation, the presence and parsing of a table of contents, or an explicit outline in the document proper. The total volume of regulations is staggering. In fact, the United States Code of Federal

Regulations alone is 185,434 pages, containing more than 100 million words. Meanwhile, each U.S. state typically has somewhere between 62,000 and 308,000 regulatory restrictions. Entities are required to comply with every applicable regulation at the federal, state, and local level. As an entity such as a company expands into a new geography, it is potentially subjected to additional regulations. This dizzying amount of paperwork leaves all but the most prepared entities struggling to keep up. As new regulations are introduced, entities must spend the time to understand them, so that they ensure compliance with all applicable regulatory requirements. The pace of regulatory changes is often challenging to maintain. From 2013 to 2018, the Code of Federal Regulations saw an increase of 9,938 pages—an increase of more than 5%.

Although regulations are necessary to protect against maliciousness and negligence, a significant amount of time and effort is required to manage all this regulatory change paperwork. Regulators, however, expect compliance. The tedious nature of this task naturally produces errors, which can be costly. These errors can cost a significant amount of time, and, if they are found by regulators, errors can result in the issuance of required corrective actions or fines.

Companies and other entities typically utilize compliance management and regulatory change software to aid in this process. Regulatory change software often contains capabilities to alert an entity when updates occur with respect to new or potential regulations. Compliance management software enables entities to quickly and easily demonstrate compliance with the regulations they have processed.

A gap exists in that it is challenging and time consuming to process a new or updated regulation. New or updated regulations that have not yet been reviewed prove difficult in terms of demonstrating compliance. A significant amount of effort is required to identify all requirements in a regulation and map them to internal controls. Software may be used to automatically map requirements to controls (e.g., the control mapping service 112 of GRC system 102), but to do so the software typically needs the requirements to be stored in a structured format, where each requirement is separately identified. The software cannot readily and accurately produce the mappings of regulations to controls if the source of the regulations (e.g., one or more regulatory documents) are in an unstructured format.

There is thus a need for solutions that reduce the number of errors, as well as the time, effort and resources consumed, in managing the process of mapping regulations to controls. With that goal in mind, illustrative embodiments provide solutions for automatically detecting document structure. The solutions, in some embodiments, may present the results to associated users for confirmation. To maintain flexibility, the solutions described herein enable the users to make modifications to the results. For example, users may add items, delete items, merge levels, split levels, or perform other actions on the results. By accomplishing these, the solutions will reduce user fatigue and thereby reduce errors.

NLP packages, such as Stanford NLP and LexNLP, may be used to perform tasks such as sentence boundary detection, paragraph identification, part of speech tagging, named entities recognition, stemming and lemmatization, and computation of domain-specific stop lists and stop words removal. In addition, some approaches attempt to extract document structure based on or relying on statistical methods, or attempt to capture the document structure of paragraphs rather than an arbitrary-depth outline. Some techniques also attempt to extract document structure by relying on bookmarks or specific outline identifiers. Such various techniques, however, are not able to identify the lexical structure of a legal or other regulatory document that contains a sequence of distinct but arbitrarily nested components and subcomponents. Components may consist of various enumerators and sequence text paragraphs. These components represent the structure of a regulation and in an illustrative use case, are mapped to regulatory controls (e.g., using the control mapping service 112 of GRC system 102).

As noted above, some companies or other entities rely on manual efforts to read and parse regulatory documents. Such entities, including entities that utilize compliance management software such as RSA Archer®, would benefit from the techniques described herein for automatically identifying internal document structure. Performing this task by hand requires a significant amount of time and effort. As a result, the impact of the solutions described herein provide significant benefits in reducing manual effort, time and other resources, including where an entity uses regulatory compliance management software, especially if that software requires that regulatory requirements are in a structured format. For example, some regulatory compliance management software expects or requires that each nested component of a regulatory document exists as its own record. The regulatory compliance management software may also require information regarding parent-child relationships between each of the records to maintain the cohesiveness of the regulatory document. Examples of regulations that may require conversion to a structure format include, but are not limited to, federal, state and local government regulations, International Organization for Standardization (ISO) and National Institute of Standards and Technology (NIST) regulations, etc.

In some embodiments, the structure of regulatory documents (e.g., one or more regulations contained therein) is captured as a CFG. Techniques from compiler theory are utilized, and the structure of regulatory documents or one or more regulations contained therein may be expressed as a CFG. Various tools, such as those in the category of Yet-Another-Compiler-Compiler (YACC), are leveraged to automatically generate recursive descent parsers for the regulations.

In general, the structure of all regulations in the world is not expressible as a CFG, because there is a fair amount of context-sensitivity in the enumeration and the expression of nested levels of different regulatory documents (e.g., it is provable that there is no CFG that generates all regulations in the world). The techniques described herein, however, surmount these obstacles enabling a solution the expresses the structure of regulations as a CFG (e.g., with a potentially large set of derivation rules) by making some simplifying assumptions about the depth of the nested structure and the number of subcomponents.

In some embodiments, a solution (referred to herein as a “first” solution) for building a syntax parse tree assumes that the nested structure of a regulatory document has depth by at most some threshold number (e.g., a relatively small number as described in further detail below), and that each level of the nested structure has a distinct enumeration type. In other embodiments, a solution (referred to herein as a “second” solution), assumes that the depth of the nested structure is finite but unknown, and that each level of the nested structure uses a same enumeration type. In still other embodiments, aspects of the first and second solutions may be combined, or both the first and second solutions may be used. Advantageously, both the first and second solutions are able to apply the idea of CFGs to parsing regulations and surmounting the inherent context sensitivity in the structure of the regulations. In some embodiments, compiler technology such as the YAAC technology is utilized for language recognition and applied to the problem of extracting structure and parsing legal or other regulatory documents.

In some embodiments, both the first and second solutions (which are described in further detail below) assume that the regulatory document under consideration has an internal document structure that can be identified and automatically parsed. In the description below, algorithms are provided for automatically identifying and parsing the internal document structure in both the first and second solutions. The first and second solutions return a syntax parse tree, which is a specific structured format that can be easily converted to another form that is ready for consumption by software that requires structured data (e.g., compliance management software). As used herein, the term “syntax parse tree” refers to the returned format of the first and second solutions, while the term “structured format” is used to generically describe a structured version or representation of a regulatory document, where a syntax parse tree is an example of such a structured version or representation of a regulatory document.

The solutions described herein accept as input an unstructured document (e.g., an unstructured version of a given document), and return a structured form of the document (e.g., a structured version of the given document). To accomplish this goal, the document must contain an internal structure. In some embodiments, it is assumed that the internal document structure is a hierarchical outline, which is a tree structure. This assumption implies a nested structure that requires every element of the outline to have a parent-child relationship with the hierarchical level above it, with the exception of the highest or topmost level.

In some embodiments, it is further assumed that the document contains identifiers so that the solutions described herein will be able to properly identify the structure. Examples of identifiers include formatted text (e.g., bold, underlined or italicized text), outline prefixes (e.g., a, b, . . . , A, B, I, II, . . . , 1, 2, . . . , Article 1., Article 2., . . . , etc.), etc. The outline prefixes may include parenthesis, brackets, periods, dashes, etc. (e.g., (a), a), [a], [a], a., a-, etc.). Some embodiments further assume that the identifiers occur at the beginning of a line (e.g., possibly with indentation or leading whitespace). If identifiers do not occur at the beginning of a line, they would be extremely difficult to accurately identify even for a human user. It should be appreciated that the particular examples of formatted text and outline prefixes listed above and described below are presented by way of example only, and that embodiments are not limited solely to use with these text formats or outline prefixes.

The solutions described herein for automatically identifying internal document structure will perform best if the internal document structure is self-consistent. The first solution (also referred to herein as the “finite-depth CFG solution”) uses a brute force method to identify the correct internal structure. The second solution (also referred to herein as the “arbitrary depth CFG solution”) expects a specific internal structure. If the document structure is inconsistent, then these solutions may not correctly identify the full structure. The solutions will still likely be able to identify a portion of the correct structure, but this depends on the particular inconsistencies and outline.

Context-free grammars, or CFGs, are a powerful mathematical formalism describing a class of languages that observe certain recursive structure. CFGs are used to define the syntax of most programming languages and the parser component of most compilers. Interpreters extract the meaning of a program based on the CFG that is used to define a language construct. A context-free language is described by a context-free grammar which we formally describe next. A CFG is a 4-tuple <V, T, P, S>, where: V is a finite set of variables, also referred to as non-terminal symbols; T is the language alphabet, T being a finite set of terminal symbols and disjoint from V; P is a finite set of derivation rules, or productions, that represent the recursive nature of the language being defined; and S is a start symbol and belongs to V.

Let G be a CFG, V be the set of variables, T be the set of terminals, P be the set of productions, and S be the start symbol. A CFG, G, is a four tuple of G=<V,T,P,S>. Productions are written as A→B, where A is (partially) defined by B. To make this more concrete, let's consider an example. Consider a language describing palindromes, Lₚ. A palindrome is a string that, when reversed, produces the same string. “Never odd or even” and “A man, a plan, a canal—Panama” are examples of common palindromes. For simplicity, suppose that we only consider languages of 0 and 1, so that T={0, 1}. The productions, P, for this grammar are the following:

A″∈|0″1|0A0|1A1

The CFG is defined as G=<{A}, {0,1}, P, A>. To expand the terminals so that T={[a−zA−Z0−9]}, then the list of productions would need to be expanded to include A→α and A→αAα for each α ∈ T.

Likewise, a CFG can be used to define, to some extent, the structure of a regulatory document. CFGs are useful, because they can describe a wide set of languages. Regulatory documents are assumed to be structured and recursive, which means that CFGs can be used to generate a parser that recognizes the regulatory documents.

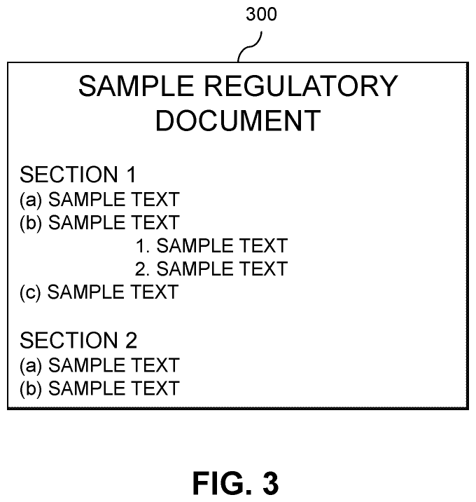

FIG. 3 shows an example of a regulatory document 300 with an internal nested hierarchical structure. The highest or top level of the structure is of the form SECTION α, where α ∈ [symbol] . In other words, the top level's indicator starts with the capitalized word, SECTION, and is followed by a space and a positive integer. It must also identify that the second level is of the form, (β) where β=[a−z]+. In other words, the second level must start with an open parenthesis, followed by one or more lowercase alphabet letters, followed by a closed parenthesis. Finally, the solution must recognize the third and lowest level as α., where α ∈ [symbol] . In other words, the lowest level starts with a positive integer followed by a period.

Let the non-terminals for this grammar be V={A, B, C, D, E}. Let the terminals be T={∈, SECTION α, (⊕), α., text}, where α ∈ [symbol] , β=[a−a−z] +. For clarification, text equals all characters except for lines that begin with one of the outline identifiers (e.g., SECTION α). This purpose of text is to capture all text that follows an outline identifier and occurs before the next outline identifier. The five production rules, P, for the regulatory document 300 are: (1) A→∈|EA|SECTION αBA; (2) B→∈EB|(β)C; (3) C→∈|EC|α. D; (4) D→∈|ED; and (5) E→∈|text. The CFG is defined as G=<{A, B, C, D, E}, T, P, A>.

Notice that the cardinalities of V, T, and P depend on the depth of the structure of the document. The items included in T will always be the union of E, text, and the set of outline identifiers. The cardinalities of V and P depend on the cardinality of T. As a result, the definition of G will depend on the specified identifiers and the proposed depth of the outline structure.

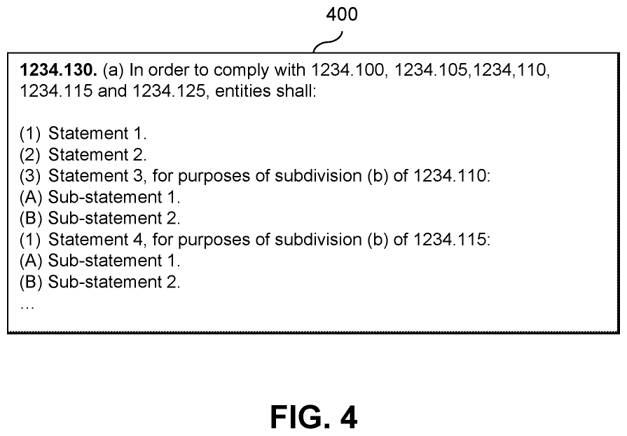

Another sample of a regulation where indentation is not present, and the nested structure (e.g., syntax parse tree or outline) is not easily extracted using standard NLP tools is shown in the sample regulatory document 400 of FIG. 4. The solutions described herein can define a CFG that recognizes and generates the syntax parse tree of regulations that have similar structure as the one in regulatory document 400 of FIG. 4.

In some embodiments, a shorthand is used for defining a CFG, where the grammar is defined according to CFG (I₁, I₂ , . . . , Iₙ), where Iᵢ represents the identifier for the ith nesting level. The number of identifiers, n, determines the depth of the grammar, while the ordering of the identifiers determines the particular outline structure the grammar will parse. This shorthand assumes that ∈ and text are included along with {I₁, I₂, . . . Iₙ} as the set of terminals, T, and it assumes that V and P are properly accounted for by the algorithm in accordance with the examples above.

The finite-depth CFG solution (e.g., the first solution) will now be described in more detail. Given a regulatory document containing text data with a nested hierarchical structure, where the nested hierarchical structure includes sections and subsections of arbitrary degree of nesting, a syntax parse tree of the regulatory document is extracted by capturing some of the structure of the regulation as a CFG. Without this last requirement, a trivial syntax parse tree including just the first nested level could be returned. The syntax parse tree should return both identifiers and associated text for each of the document components and subcomponents.

In some embodiments, the finite-depth CFG solution maintains a knowledge base of all known list types, L. A given list type, [symbol] ∈ L, is an indicator that is used to identify the structure within the document. For example, list types found in the regulatory document 300 of FIG. 3 are {SECTION α, (β), α.}, where α ∈ [symbol] , β=[a−z]+. These list types are a subset of the list types that may be found in a plurality of regulatory documents. As noted above, it is assumed in some embodiments that the list types will exist at the beginning of a line. Otherwise, it would be confusing for a computer (or a human user) to properly identify the list type. For example, if enumerated items do not appear at the beginning of a line it may not be possible to distinguish between a reference to a regulation and its definition. Most regulatory documents use enumeration constructs, and the above-described assumptions generally hold true.

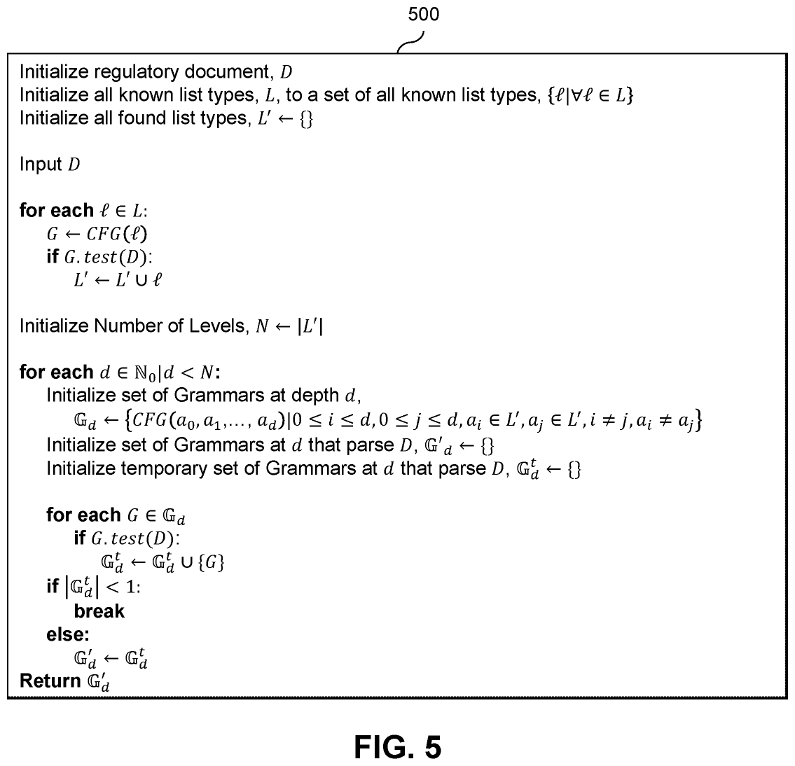

Once the regulatory document of interest has been established, the finite-depth CFG solution may be implemented using the pseudocode 500 shown in FIG. 5. The algorithm implemented by the pseudocode 500 will now be described. First, the algorithm identifies all list types that exist in the document, and it keeps a list of those found types. This is accomplished by creating a CFG of length l for each list type [symbol] ∈ L. The solution uses those CFGs to identify whether each list type can be found in the document. If no list types are found, then the finite-depth CFG solution cannot parse the document, otherwise, the algorithm can continue.

For example, let D be the regulatory document (e.g., the regulatory document 300 of FIG. 3). Let L={SECTION α, (β), α., α. α., Article α, (γ)}, where α ∈ [symbol] , β=[a−z]+, γ=[A−Z]+. Let { [symbol] | [symbol] ∈ L ∩ [symbol] ∈ D}=L′⊆L be the list types that are found in D. Let [symbol] ∈ L be a list type that exists in L. In order to include [symbol] in L′, it must be the case that [symbol] ∈ D. Let G=CFG ( [symbol] ) be a CFG of depth one that includes [symbol] ∈ L. If G can parse the regulatory document, D, then [symbol] exists in D. If G cannot successfully parse the document, then [symbol] ∈ D. This algorithm loops over all these CFGs G ∈ [symbol] ₁, identifying which list types exist in D. This would result in L′={SECTION α, (β), αa.}, where α ∈ [symbol] +, β=[a−z]+ for the regulatory document 300 in FIG. 3.

Once the list types that exist in the document have been identified, the finite-depth CFG solution then attempts to identify the proper depth of the regulatory document structure. This is performed as follows:

1. Construct all possible CFGs [symbol] _{d} at depth of d. Each CFG is one of the possible d-tuples that can be selected from L′ without replacement. In other words, select all possible partial permutations from L′ of length d. Each CFG represents one of these partial permutations. For example, if d=2 and L′={SECTION α, (β), α.|α ∈ [symbol] , β=[a−z]+}, the CFGs would be [symbol] ₂={CFG (SECTION α, (β)), CFG(SECTION α, α.), . . . }.

2. Test all CFGs. If at least one CFG passes, then the possible depth of this document is at least d.

3. If no CFGs can parse the document, then return the successful CFGs of depth d−1. Otherwise, continue.

4. If the cardinality of L′ is no larger than d, return the successful CFGs of depth d. Otherwise, continue.

5. Increase the depth, d, by 1.

6. Return to step 1.

Since a depth of 1 has already been tested, this depth does not need to be repeated. The first depth that would need to be tested is a depth of 2. If only one list type was found in the document, then the successful CFGs of depth 1 can be returned. If this is not the case, then the solution loops through these steps until either all CFGs at a particular depth fail, or CFGs with a depth equivalent to the cardinality of L′ have attempted to parse the document.

The set of CFGs that were capable of parsing the document will be returned for the highest value of d that was successful. For example, if there exist CFGs of depth 4 that were able to parse the document, but all CFGs of depth 5 failed to parse, then the successful CFGs of depth 4 will be returned.

It is important to note that, in some embodiments, it is desirable to produce an output with only one CFG. If the solution returns only one CFG, then the result is unambiguous with respect to the list types that were found in the document. On the other hand, if the solution returns more than one CFG, it is not clear which of the CFGs is correct.

Systems that incorporate the finite-depth CFG solution (e.g., GRC system 102) should account for the possibility of ambiguity in the results. To do so, the GRC system 102 may provide a mechanism (e.g., an alert or notification delivered via one or more host agents as described above, an interactive graphical user interface (GUI), etc.) for presenting the results to the end user. The end user may also be enabled to make modifications, which include adding additional list items in the grammar, removing list items, merging list items, splitting list items, modifying where particular identifiers begin and end, etc.

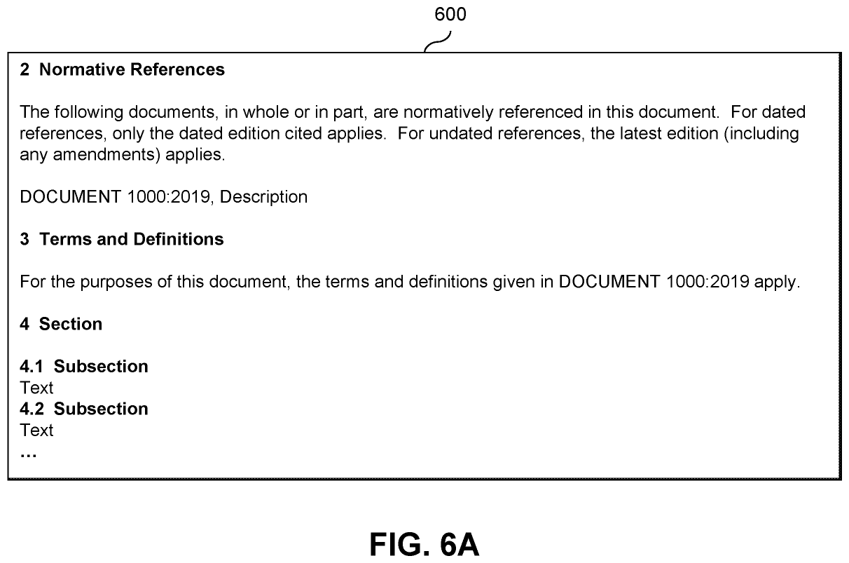

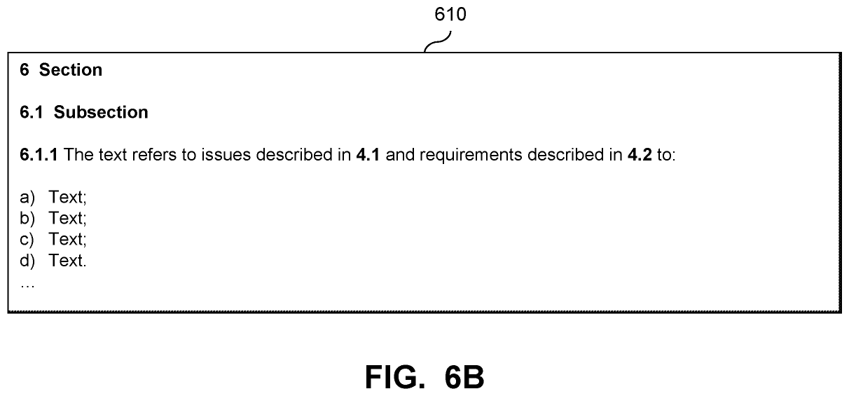

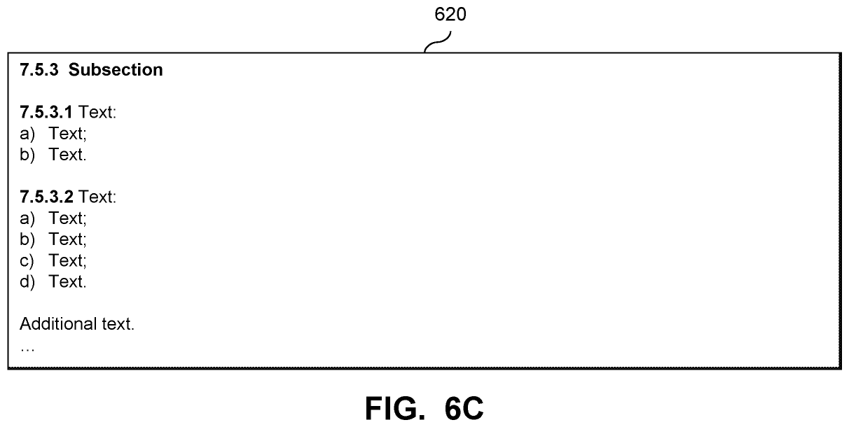

The arbitrary depth CFG solution (e.g., the second solution) will now be described in detail. Certain types or classes of regulatory documents may have a common internal hierarchical structure. As an example, ISO and NIST standard bodies typically use Arabic numbers for enumeration, and subcomponent nesting depth can be arbitrary. Even within the same document, various components may have differing depths. FIGS. 6A-6C show examples 600, 610 and 620, respectively, of text that follows such a format (e.g., as used in some ISO and NIST regulations). Note that in FIGS. 6A-6C, there is no indentation of the sections and subsections that indicates the nested hierarchical structure. In other embodiments, however, indentation may be present and used as desired by the solutions described herein.

In the examples 600, 610 and 620 of FIGS. 6A-6C, each component or subcomponent begins with a numeric string defining the level of the component, followed by an arbitrary length text which is the name of the component. The “name” or title of a component or subcomponent may be viewed as equivalent to section titles in documents. Section titles can be easily recognized and extracted using NLP processors, as they are a sequence of words that are not terminated by periods, and periods only appear as part of abbreviation. Section titles are usually short and will rarely ever extend to more than two lines, especially in regulatory documents. Sometimes, a table of contents (ToC) is present (e.g., in some NIST or ISO regulations), but the ToC may be largely incomplete (e.g., there are usually subcomponents or subsections found in the regulatory document that are not present in the ToC). The ToC, in many cases, is limited to higher level sections, while in the body of the regulation sections can be further divided into one or more levels of subsections for structure and clarity. For example, the ToC of some ISO regulations may contain only three levels of nesting while the actual regulations contain four or more levels of nesting.

The body of the component can be a sequence of paragraphs or other nested components, also referred to herein as subcomponents. A text paragraph is a sequence of sentences and ends with a new line. A text paragraph that appears in the body of a component does not begin with a string of numbers and periods (or other list types). It should be noted that indentation is not required to be used in documents with arbitrary depth and nesting of components. In some cases, were indentation to be used, the indentation would cause the body of some sections to be shifted so far to the right margin (e.g., depending on the number of levels) that the page is mostly empty. In some cases, however, indentation may be used for at least some of the subcomponent levels.

The arbitrary depth CFG solution extracts all the components at a given level in the nested hierarchical structure of a regulatory document. The identification of the subcomponents of each component is performed recursively, by treating the component as a document. A recursive descent parser is generated that recognizes all sections at the top level, and assumes that all enumerations are numeric. In the examples 600, 610 and 620 of FIGS. 6A-6C, the top sections are parsed, and every subsection

$$\underbrace{N . N . N . . . . N}_{l} ,$$

where the depth of the nesting of subcomponents is arbitrary (e.g., such that l is not bound but will be the depth of the recursive calls). The recursive descent parser will identify all the components at the top level. For example, initially at the top level, l=0, the parser will identify a first component (not shown in FIGS. 6A-6C), a second component (e.g., “2 Normative References” shown in example 600 of FIG. 6A), a third component (e.g., “3 Terms and Definitions” shown in example 600 of FIG. 6A), a fourth component (e.g., “4 Section” shown in example 610 of FIG. 6B), and so on. Recognizing and identifying all the children or subcomponents of the components is done by calling the parser recursively on each identified component.

An algorithm for implementing the arbitrary depth CFG solution is as follows:

1. Define a CFG that can identify and extract all components at a given level (e.g., only one level) in the nested hierarchical structure of a regulatory document.

2. Suppose that there is a limit on the number of components at the given level (e.g., a limit of 100). The derivation rules of the CFG are used to generate a recursive descent parser for extracting the components will have the following form:
a. S→L1|L2| . . . |L100
b. L1→C1
c. L2→C1 C2
d. . . .
e. L100→C1 C2 . . . C100
f. C1→1<Title><Body>
g. C2Δ2<Title><Body>
h. . . .
i. C100→100<Title><Body>
j. <Title>→<text terminating with a new line>
k. <Body>→<sequence of paragraphs that don't begin with a number>NLP packages that are used to recognize paragraphs perform reasonably well at sentence boundary detection.

3. A recursive descent parser is generated to extract the structure of the document at one level (e.g., using one or more YACC tools and the above-described CFG rules). The parser function, P(l, D), takes two arguments. The first is the level, and the second is the input text (or document) to be parsed. Initially P(0, D) is called to extract the top-level structure, which is the components or the sections and their text. From the examples 600, 610 and 620 of FIGS. 6A-6C, the following top-level structure is extracted:
1 . . .
2 Normative References
3 Terms and Definitions
4 Section . . .
6 Section
. . .

4. The same parser may be used to recognize subcomponents of a given component recursively (e.g., the arbitrary depth). The parameter l is used to remove l leading enumerations (e.g., including the periods in the examples 600, 610 and 620 of FIGS. 6A-6C) from each number of a section in the recursive calls of the parser.

For example, if P(l, D) returns three components, denoted as C1, C2, and C3, then the algorithm calls P(l+1, C1), P(l+1, C2), and P(l+1, C3) to identify subcomponents of the three components. Removing l+1 enumerations from the numerical strings leading each component name transforms the body of the component to a top-level document.

In summary, to build the syntax parse tree of regulations with arbitrary depth of nested sections or components, the algorithm parses one level at a time and recursively extracts substructure of each component by removing a prefix of the depth of the recursion from the strings identifying the section numbers. Note that the arbitrary depth CFG solution approach is not limited for use with the Arabic number format in the examples 600, 610 and 620 of FIGS. 6A-6C. The arbitrary depth CFG solution approach may also be used for documents that utilize various other formats for identifying components and subcomponents, including but not limited to Roman numerals (e.g., I.I, I.II, . . . , II.I, II.II, . . . , etc.), alphabet letters (e.g., A.A, A.B, . . . , B.A, B.B, . . . , etc.), combinations thereof, etc. It should further be appreciated that the nested structure in such cases is not limited to using periods for delineation. For example, dashes (e.g., 1-1, 1-2, . . . , 2-1, 2-2, . . . , etc.), underscores (e.g., 1_1, 1_2, . . . , 2_1, 2_2, . . . , etc.), parenthesis (e.g., (1)(1), (1)(2), . . . , (2)(1), (2)(2), . . . , etc.), brackets (e.g., [1][1], [1][2], . . . , [2][1], [2][2], . . . , etc.), and various other delineators may be used, including various combinations thereof.

In some embodiments, one or both of the finite-depth CFG solution and the arbitrary depth CFG solutions may be extended to utilize common structure inference. After such solutions are run on a large enough (e.g., exceeding some defined threshold) corpus of documents, statistics could be kept on common document structure patterns. As the solutions are run on a new document, the most likely CFGs (e.g., corresponding to the common document structure patterns) could be tested first. Additionally, if a solution returns more than one CFG, the most likely CFG may be suggested (e.g., to an end user) if one exists.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

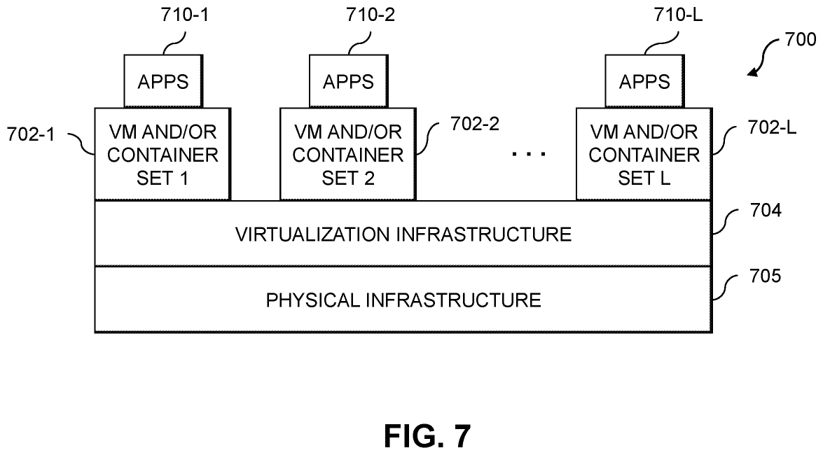

Illustrative embodiments of processing platforms utilized to implement functionality for determining syntax parse trees for extracting nested hierarchical structures from text data will now be described in greater detail with reference to FIGS. 7 and 8. Although described in the context of system 100, these platforms may also be used to implement at least portions of other information processing systems in other embodiments.

FIG. 7 shows an example processing platform comprising cloud infrastructure 700. The cloud infrastructure 700 comprises a combination of physical and virtual processing resources that may be utilized to implement at least a portion of the information processing system 100 in FIG. 1. The cloud infrastructure 700 comprises multiple virtual machines (VMs) and/or container sets 702-1, 702-2, . . . 702-L implemented using virtualization infrastructure 704. The virtualization infrastructure 704 runs on physical infrastructure 705, and illustratively comprises one or more hypervisors and/or operating system level virtualization infrastructure. The operating system level virtualization infrastructure illustratively comprises kernel control groups of a Linux operating system or other type of operating system.

The cloud infrastructure 700 further comprises sets of applications 710-1, 710-2, . . . 710-L running on respective ones of the VMs/container sets 702-1, 702-2, . . . 702-L under the control of the virtualization infrastructure 704. The VMs/container sets 702 may comprise respective VMs, respective sets of one or more containers, or respective sets of one or more containers running in VMs.

In some implementations of the FIG. 7 embodiment, the VMs/container sets 702 comprise respective VMs implemented using virtualization infrastructure 704 that comprises at least one hypervisor. A hypervisor platform may be used to implement a hypervisor within the virtualization infrastructure 704, where the hypervisor platform has an associated virtual infrastructure management system. The underlying physical machines may comprise one or more distributed processing platforms that include one or more storage systems.

In other implementations of the FIG. 7 embodiment, the VMs/container sets 702 comprise respective containers implemented using virtualization infrastructure 704 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 700 shown in FIG. 7 may represent at least a portion of one processing platform. Another example of such a processing platform is processing platform 800 shown in FIG. 8.

The processing platform 800 in this embodiment comprises a portion of system 100 and includes a plurality of processing devices, denoted 802-1, 802-2, 802-3, . . . 802-K, which communicate with one another over a network 804.

The network 804 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 802-1 in the processing platform 800 comprises a processor 810 coupled to a memory 812.

The processor 810 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU) or other type of processing circuitry, as well as portions or combinations of such circuitry elements.

The memory 812 may comprise random access memory (RAM), read-only memory (ROM), flash memory or other types of memory, in any combination. The memory 812 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 802-1 is network interface circuitry 814, which is used to interface the processing device with the network 804 and other system components, and may comprise conventional transceivers.

The other processing devices 802 of the processing platform 800 are assumed to be configured in a manner similar to that shown for processing device 802-1 in the figure.

Again, the particular processing platform 800 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality for determining syntax parse trees for extracting nested hierarchical structures from text data as disclosed herein are illustratively implemented in the form of software running on one or more processing devices.

It should again be emphasized that the above-described embodiments are presented for purposes of illustration only. Many variations and other alternative embodiments may be used.

For example, the disclosed techniques are applicable to a wide variety of other types of information processing systems, document types, list types, hierarchical structures, etc. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. An apparatus comprising:
at least one processing device comprising a processor coupled to a memory;
the at least one processing device being configured to perform steps of:
obtaining an unstructured version of a document comprising text data, the text data having a nested hierarchical structure comprising two or more levels;
determining a syntax parse tree for the nested hierarchical structure, the syntax parse tree specifying one or more list types associated with items in at least a given one of the two or more levels in the nested hierarchical structure;
identifying, in the document, a plurality of items each having one of the specified one or more list types in the syntax parse tree;
extracting, from the document, portions of the text data corresponding to respective ones of the plurality of items; and
generating a structured version of the document that associates the extracted portions of the text data with the corresponding ones of the plurality of items.

2. The apparatus of claim 1 wherein the syntax parse tree comprises a context free grammar having a depth corresponding to a number of the two or more levels in the nested hierarchical structure and an ordering of a set of terminal symbols corresponding to an ordering of identifiers for list types of the two or more levels in the nested hierarchical structure.

3. The apparatus of claim 1 wherein determining the syntax parse tree comprises:
identifying whether respective ones of a set of known list types are present in the document;
determining a number of the two or more levels in the nested hierarchical structure; and
selecting a context free grammar with the identified ones of the known list types present in the document and having a depth corresponding to the determined number of the two or more levels in the nested hierarchical structure.

4. The apparatus of claim 3 wherein identifying whether respective ones of the set of known list types are present in the document comprises, for a given one of the set of known list types:
generating a given parser for a context free grammar of depth one for the given known list type; and
analyzing the document with the given parser to determine whether any items with the given known list type are found in the document.

5. The apparatus of claim 3 wherein determining the number of the two or more levels in the nested hierarchical structure comprises:
generating a plurality of parsers each comprising a combination of two or more identified ones of the known list types at two or more different depths corresponding to different ones of the two or more levels in the nested hierarchical structure;
analyzing the document with respective ones of the plurality of parsers to determine a subset of the plurality of parsers able to successfully parse the document, wherein a given one of the plurality of parsers having a given depth is able to successfully parse the document when the given parser finds at least one item at each level in the given depth; and
determining the number of the two or more levels in the nested hierarchical structure as a longest depth among the subset of the plurality of parsers able to successfully parse the document.

6. The apparatus of claim 5 wherein determining the syntax parse tree comprises selecting one of the subset of the plurality of parsers having the longest depth.

7. The apparatus of claim 5 wherein, when there are two or more parsers in the subset of the plurality of parsers having the longest depth, providing the two or more parsers having the longest depth to a client device for selection of one of the two or more parsers having the longest depth as the syntax parse tree.

8. The apparatus of claim 1 wherein the syntax parse tree comprises a context free grammar with an arbitrary depth where a common list type is used for items in each of the two or more levels in the nested hierarchical structure.

9. The apparatus of claim 8 wherein identifying the plurality of items comprises generating a recursive descent parser based at least in part on the context free grammar, and utilizing the recursive descent parser to identify subsets of the plurality of items at each of the two or more levels in the nested hierarchical structure.

10. The apparatus of claim 9 wherein the recursive descent parser comprises a parser function that takes as input an identifier of a given one of the two or more levels in the nested hierarchical structure and a given portion of the text data of the document.

11. The apparatus of claim 10 wherein when the given level in the nested hierarchical structure comprises a topmost one of the two or more levels in the nested hierarchical structure, the given portion of the text data comprises all of the text data of the document.

12. The apparatus of claim 10 wherein when the given level in the nested hierarchical structure comprises a first one of the two or more levels in the nested hierarchical structure, the given portion of the text data comprises all text data for a given component in a second one of the two or more levels in the nested hierarchical structure, the second level being higher than the first level.

13. The apparatus of claim 10 wherein the identifier of the given level in the nested hierarchical structure indicates a leading portion of enumerations of the common list type to be removed prior to parsing the given portion of the text data of the document.

14. The apparatus of claim 1 wherein the document comprises a regulatory document specifying one or more requirements for operation of assets in an information technology (IT) infrastructure, and wherein the at least one processing device is further configured to perform the step of utilizing the structured version of the document to map the specified one or more requirements to controls for operating the assets in the IT infrastructure.

15. A computer program product comprising a non-transitory processor-readable storage medium having stored therein program code of one or more software programs, wherein the program code when executed by at least one processing device causes the at least one processing device to perform steps of:
obtaining an unstructured version of a document comprising text data, the text data having a nested hierarchical structure comprising two or more levels;
determining a syntax parse tree for the nested hierarchical structure, the syntax parse tree specifying one or more list types associated with items in at least a given one of the two or more levels in the nested hierarchical structure;
identifying, in the document, a plurality of items each having one of the specified one or more list types in the syntax parse tree;
extracting, from the document, portions of the text data corresponding to respective ones of the plurality of items; and
generating a structured version of the document that associates the extracted portions of the text data with the corresponding ones of the plurality of items.

16. The computer program product of claim 15 wherein the syntax parse tree comprises a context free grammar having a depth corresponding to a number of the two or more levels in the nested hierarchical structure and an ordering of a set of terminal symbols corresponding to an ordering of identifiers for list types of the two or more levels in the nested hierarchical structure.

17. The computer program product of claim 15 wherein the syntax parse tree comprises a context free grammar with an arbitrary depth, wherein a common list type is used for items in each of the two or more levels in the nested hierarchical structure.

18. A method comprising:
obtaining an unstructured version of a document comprising text data, the text data having a nested hierarchical structure comprising two or more levels;
determining a syntax parse tree for the nested hierarchical structure, the syntax parse tree specifying one or more list types associated with items in at least a given one of the two or more levels in the nested hierarchical structure;
identifying, in the document, a plurality of items each having one of the specified one or more list types in the syntax parse tree;
extracting, from the document, portions of the text data corresponding to respective ones of the plurality of items; and
generating a structured version of the document that associates the extracted portions of the text data with the corresponding ones of the plurality of items;
wherein the method is performed by at least one processing device comprising a processor coupled to a memory.

19. The method of claim 18 wherein the syntax parse tree comprises a context free grammar having a depth corresponding to a number of the two or more levels in the nested hierarchical structure and an ordering of a set of terminal symbols corresponding to an ordering of identifiers for list types of the two or more levels in the nested hierarchical structure.

20. The method of claim 18 wherein the syntax parse tree comprises a context free grammar with an arbitrary depth, wherein a common list type is used for items in each of the two or more levels in the nested hierarchical structure.
